(19) United States
(12) Patent Application Publication
(10) Pub. No.: US 2012/0075699 A1
(43) Pub. Date: Mar. 29, 2012

(54) SEGMENTED FILM DEPOSITION

(76) Inventors: Mark Alan Davis, Springville, UT (US); Benjamin Spencer Center, Ephrata, WA (US)

(21) Appl. No.: 13/075,470

(22) Filed: Mar. 30, 2011

Related U.S. Application Data
(63) Continuation-in-part of application No. 12/507,570, filed on Jul. 22, 2009.
(60) Provisional application No. 61/109,250, filed on Oct. 29, 2008.

(51) Int. Cl. G02B 27/28; B32B 3/10; B05D 3/10; C23F 1/02; B05D 5/00; B05D 5/12

(52) U.S. Cl. 359/492.01; 427/265; 427/58; 216/83; 428/172

(57) ABSTRACT

A segmented film deposition device and a method of performing segemented film deposition. A wire grid polarizer, with a separate, symmetrical, coating on top of each wire, without coating the substrate between the wires, can be made by this method.

### CLAIM OF PRIORITY

This is a continuation-in-part of U.S. patent application Ser. No. 12/507,570, filed on Jul. 22, 2009; which claims priority to U.S. Provisional Patent Application Ser. No. 61/109,250, filed on Oct. 29, 2008; which are herein incorporated by reference.

### BACKGROUND

As shown in FIG. 1, a wire grid polarizer 10 can comprise an array of wires or wires 12 on a substrate 11. The wires have a pitch P, designed to allow polarization of the desired electromagnetic wavelength. Additional layers 13 and 14 may be desirable for improved polarizer performance. For example, the additional layers 13 and 14 can result in improved transmission of the desired polarization or can absorb the unwanted polarization. Layer 13 and layer 14 can represent a single layer each or can represent multiple layers.

The wire grid polarizer of FIG. 1 can be made by applying layer 12 as a continuous film, applying the desired additional layers 13 and 14, then patterning and etching through all films at one time to create the wire structure 15. The requirement of etching through layers 12, 13, and 14 can create manufacturing difficulties and/or polarizer structural limitations. For example, the aspect ratio, as defined by wire height H divided by wire width W, can have an upper limit due to the difficulty of etching structures with high aspect ratios (H/W). Some materials, which may be desirable to use as layers 13 or 14, can be very difficult, or perhaps even impossible, to etch. Etching through a structure with multiple different layered materials can be complex, and can require multiple etching steps and/or multiple etching tools. Note that wire width W can be substantially the same for all layers 12, 13, and 14.

In order to simplify the etching process, and to allow a greater selection of materials to be used as the additional layers 13 and 14, it may be advantageous to pattern and etch through layer 12, then sputter the added layers 13 and 14 on top of the wires 12. Two results of deposition coating on top of polarizer wires are conformal coating and directional coatings.

As shown in FIG. 2, a wire grid polarizer 20 can include a conformal coating 21. The conformal coating 21 can be sputtered on top 22 of the wires 12 and between 23 the wires 12. The conformal coating 21 can coat and conform to the surface of the wires 12. For some applications, this conformal coating 21 may be beneficial. For other applications, coating between 23 the wires 12 may be detrimental.

Wire grid polarizer 30 of FIG. 3 has coating applied from normal N incidence, resulting in coating the substrate 11 between 23 the wires 12. This coating 31 between 23 the wires 12 can be undesirable for some applications.

As shown in FIG. 4, wire grid polarizer 40 can have a coating 41a applied by shadow-coating sputtering. Coating 41a can be applied at an angle A1. Angle A1 can be typically 30-45 degrees from normal N. Results can be limited by the aspect ratio of the structure and angle of deposition. With this process, the substrate 11 area between 23 the wires 12 is not coated. Disadvantages of shadow coating include difficult process control and a coating 41a which is primarily on one side of the wire 44 but not the other side 45. A non-symmetrical coating, that is thicker on one side of a centerline C of the wires 12 than on an opposing side, or extends down one side-wall of the wires 44 but not an opposing sidewall 45, can have polarizer performance disadvantages.

As shown in FIG. 5, wire grid polarizer 50, can have a coating on both sides 44-45 of wires 12 without coating substrate 11 between 23 the wires by applying the coating in two separate steps, from two different angles A1 and A2. Angles A1 & A2 can be typically 30-45 degrees from normal N. Thus, two separate layers 41a-b can be deposited in two separate steps. A boundary layer 51 can exist between the separate layers 41a-b. This boundary layer can adversely affect the performance and durability of the structure. Also, this method of applying the coating 41a-b in two separate steps from two different angles A1 & A2 can result in a non-symmetrical coating with different thicknesses of coating at equivalent distances on either side of the centerline C of the wires. Thus T₂ might not equal T₁ at equivalent distance d from the centerline C. Distance “d” is defined as a distance along a surface of the coating between the centerline C and a half-way point between the centerline and an edge of the coating. Furthermore, coating thickness T_{c} at the centerline may not be the thickest portion. This non-symmetry in coating can affect polarizer performance.

As shown in FIG. 6, wire grid polarizer 60 can have a continuous coating 61 on a surface 22 of the wires 12 without coating between 23 the wires 12. Such a coating can protect the wires 12 but can adversely affect polarizer performance in some applications. In some applications, it would be better to have a separate coating on each individual wire, such that the coating on one wire does not touch a coating on an adjacent wire, or such that the coating on one wire touches a coating on an adjacent wire, but is separate from and does not attach to the coating on an adjacent wire.

### SUMMARY OF THE INVENTION

It has been recognized that it would be advantageous to add additional coatings, on top of wire grid polarizer wires, that are continuous and homogeneous from one side of the wire to another side of the wire. It has been recognized that it would be advantageous to apply such coatings to only the wires and not to the substrate between the wires. It has been recognized that it would be advantageous to apply such coatings symmetrically across the top of the wires, with a separate coating on each wire.

In one embodiment of the present invention, a segmented film deposition device includes a substrate with a generally parallel arrangement of thin, elongated wires disposed over the substrate. The wires have a surface opposite of the substrate and sides extending down to the substrate. A coating is disposed on the surface of the wires and continues partially down both sides of the wires without coating the substrate exposed between the wires. The coating can be continuous and homogeneous from one side of the wire to another side.

In another embodiment of the present invention, a wire-grid polarizer includes a substrate and a generally parallel arrangement of thin, elongated, conductive wires disposed over the substrate. The wires have a surface opposite of the substrate and sides extending down to the substrate. A segmented coating is disposed on the surface of the wires without coating the substrate exposed between the wires. The coating can be thickest at a centerline of the wires. Thicknesses of the coating at locations half-way between the centerline and edges of the coating can be less than 75% of a thickness of the coating at the centerline. The coating can be continuous and homogeneous across a width of the coating.

In another embodiment of the present invention, a wire-grid polarizer includes a substrate and a generally parallel arrangement of thin, elongated, conductive wires disposed over the substrate. The wires have a surface opposite of the substrate and sides extending down to the substrate. At least two segmented coating layers can be disposed on the surface of the wires without these coating layers coating the substrate between the wires. The segmented coating layers on a wire do not attach to segmented coating layers on adjacent wires. The coating layers are continuous and homogeneous across a width of the coating layers. At least two of the at least two segmented coating layers can each have thicknesses at locations half-way between the centerline and edges of the coating that are less than 95% of a thickness at the centerline. At least two of the at least two segmented coating layers can each have an absolute value of a thickness T₂ at distance d on one side of a centerline of the wires minus a thickness T₁ of the coating at the same distance d on an opposite side of the centerline divided by a larger of the two thicknesses T that is less than 0.5, wherein distance d is a distance along a surface of the coating between the centerline and a half-way point between the centerline and an edge of the coating

$$\frac{\vert {T}_{2} - {T}_{1} \vert}{T} < 0.5 .$$

In another embodiment of the present invention, a wire-grid polarizer includes a substrate and a generally parallel arrangement of thin, elongated electrically conductive wires disposed over the substrate, the wires having a surface opposite of the substrate and sides extending down to the substrate. A symmetrical coating is disposed on the surface of the wires without coating the substrate exposed between the wires. The coating is continuous and homogeneous across a width of the coating. Thicknesses of the coating at locations half-way between the centerline and edges of the coating can be less than 70% of a thickness of the coating at the centerline.

In another embodiment of the present invention, a method of performing segmented film deposition includes forming an array of parallel spaced-apart wires on a substrate and depositing a segmented film on the wires comprising individual segments on individual wires. The deposition is performed with no substantial coating of the substrate between the wires. The segments are aligned with the wires. The segments are continuous and homogeneous across a width of the coating and from one side of the wires to the other side. The segments continue partially down both sides of the wires without coating the substrate exposed between the wires. The segments on wires are separate and distinct from each other.

### BRIEF DESCRIPTION OF THE DRAWINGS

FIG. 1 is a schematic cross-sectional side view of a prior art wire grid polarizer with coated wires;

FIG. 2 is a schematic cross-sectional side view of a prior art wire grid polarizer with conformal coated wires;

FIG. 3 is a schematic cross-sectional side view of a prior art wire grid polarizer with directionally coated wires and coating on the substrate between the wires;

FIG. 4 is a schematic cross-sectional side view of a prior art wire grid polarizer with directionally coated wires;

FIG. 5 is a schematic cross-sectional side view of a prior art wire grid polarizer with directionally coated wires, coated from two different angles;

FIG. 6 is a schematic cross-sectional side view of a prior art wire grid polarizer with a continuous coating across a surface of the wire grid polarizer wires;

FIG. 7 is a schematic cross-sectional side view of a segmented film deposition device in accordance with an embodiment of the present invention;

FIG. 8 is a schematic cross-sectional side view of a segmented film deposition device in accordance with an embodiment of the present invention;

FIG. 9 is a schematic cross-sectional side view of a segmented film deposition device in accordance with an embodiment of the present invention;

FIG. 10 is a schematic cross-sectional side view of a segmented film deposition device in accordance with an embodiment of the present invention;

FIG. 11 is a schematic cross-sectional side view of a segmented film deposition device in accordance with an embodiment of the present invention;

FIG. 12 is a schematic cross-sectional side view of a segmented film deposition device in accordance with an embodiment of the present invention;

FIG. 13 is a schematic cross-sectional side view of a segmented film deposition device in accordance with an embodiment of the present invention;

FIG. 14 is a schematic cross-sectional side view of a segmented film deposition device in accordance with an embodiment of the present invention;

FIG. 15 is a schematic cross-sectional side view of a segmented film deposition device in accordance with an embodiment of the present invention;

FIG. 16 is a schematic cross-sectional side view of a segmented film deposition device in accordance with an embodiment of the present invention;

FIG. 17 is a schematic cross-sectional side view showing a method of manufacture of a segmented film deposition device in accordance with an embodiment of the present invention;

FIG. 18 is a scanning electron microscope view of a segmented film deposition device in accordance with an embodiment of the present invention;

FIG. 19 is a scanning electron microscope view of a segmented film deposition device in accordance with an embodiment of the present invention;

FIG. 20 is a scanning electron microscope view of a segmented film deposition device in accordance with an embodiment of the present invention; and

FIG. 21 is a scanning electron microscope view of a segmented film deposition device in accordance with an embodiment of the present invention.

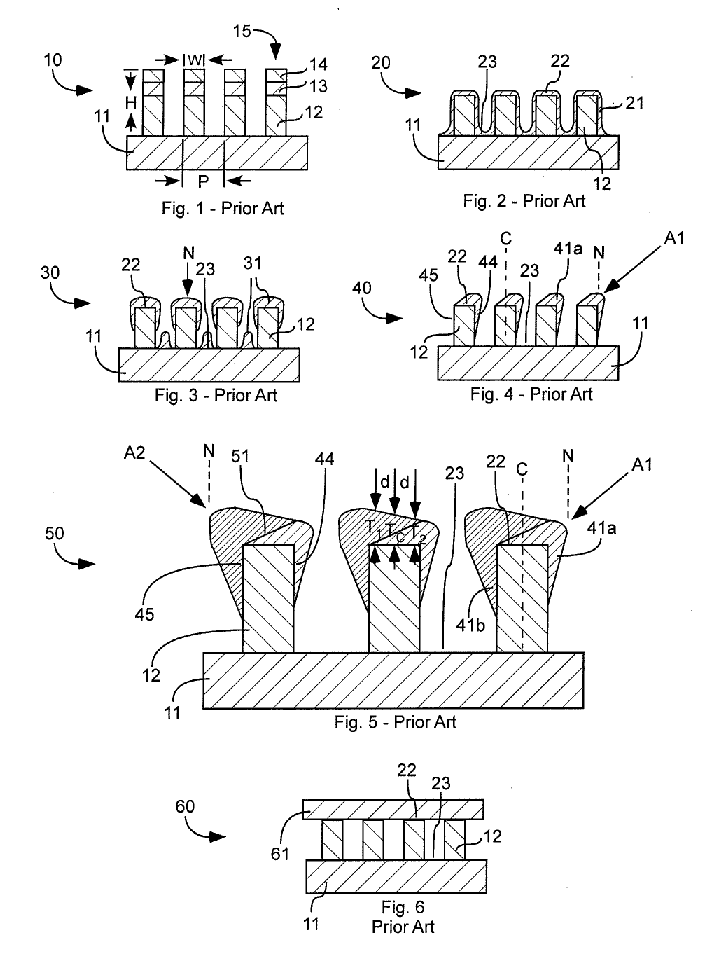

### DEFINITIONS

As used herein, the term “coating the substrate” refers to a substantial amount of coating, such as a layer of coating for example, and does not include a few atoms of coating scattered across the substrate in a non-continuous fashion.
As used herein, the term “substantially,” as in for example “no substantial coating of the substrate between the wires” means that although there may be some atoms of the coating between the wires, there is no continuous layer on the substrate between wires.
As used herein, “SFD” means “segmented film deposition.”

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

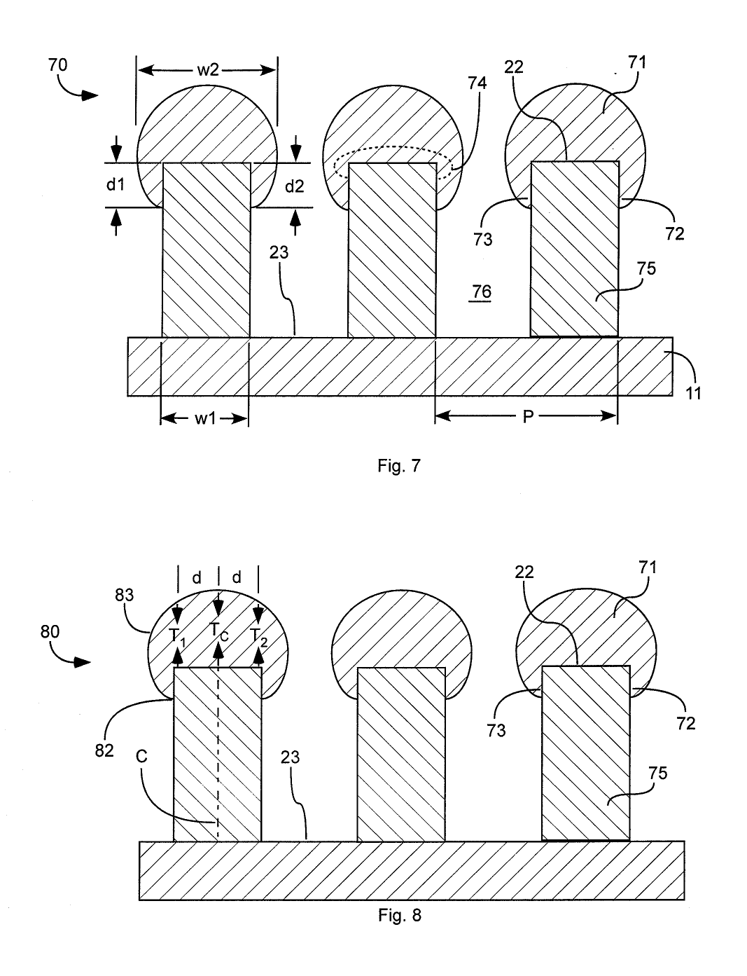

As illustrated in FIG. 7, a segmented film device 70 is shown comprising a generally parallel arrangement of thin, elongated wires 75 disposed over a substrate 11. The wires 75 can have a surface 22 opposite the substrate 11 and opposite sides 72 & 73 extending from the surface 22 down to the substrate 11. A segmented coating 71 can be disposed on the surface 22 of the wires 75 and can continue partially down both sides 72 & 73 of the wires into channels 76 between the wires 75 without coating the substrate 11 exposed between the wires 75, indicated at 23.

As shown by line 74, the coating 71 can be continuous and homogeneous from one side of the wire 72 to another side 73. This continuity and homogeneity can result from deposition of a single layer of coating in a single step, in comparison with the two step deposition described in the prior art description of FIG. 5. Thus, through deposition in a single step, the coating can be a continuous and homogeneous layer from one side of the wires to an opposite side with no boundary conditions therebetween. It can be advantageous, by reducing required manufacturing steps, to be able to apply a single coating layer in a single step. Furthermore, a continuous coating layer, without a boundary condition in a single layer on a single wire, can result in increased durability and improved polarizer performance.

In the various embodiments described herein, the substrate 11 can be any material including metal, dielectric, or polymer, depending on the desired application. A substrate 11 material that is transparent to the incoming light, whether the light is infrared, visible, or ultraviolet, may be preferred if the device is a wire grid polarizer. For example, glass may be used if the wire grid polarizer is used for polarization of visible light. The wires 75 can be the same material as the substrate 11 or can be a different material. If the segmented film device is a wire grid polarizer, an electrically conductive material for the wires 75 may be preferred. The wires 75 can be the same material as the coating 71 or can be a different material. The wires 75 and coating 71 can be any material including metal, dielectric, or polymer. The wires 75 can be a single material, or can be layers of different materials. The coating 71 can be a single material, or it can be layers of different materials (each being continuous and homogeneous across a width thereof, as described below). The coating 71, or one or more layers thereof, can be absorptive to incoming light.

Wire grid polarizers are often used for polarization of ultraviolet, visible, or infrared light. The pitch can be less than half of the wavelength of the light to be polarized. For example, pitch P can be less than 150 nanometers for polarization of visible light. Pitch P can be less than 120 nanometers, less than 100 nanometers, or less than 80 nanometers, for better polarization of the lower visible wavelengths or for polarization of ultraviolet light. Materials can be selected to optimize polarizer performance or structural characteristics.

Thin film layer materials described in U.S. Pat. No. 7,570,424 and U.S. Patent Publication 2008/0278811, which are herein incorporated by reference, can be used as coating 71 materials in the present invention. Also, substrate 11 and wire 75 materials described in U.S. Pat. No. 7,570,424 and U.S. Patent Publication 2008/0278811 can be used as substrate 11 and wire 75 materials respectively in the present invention.

Because the coatings in the various embodiments of segmented film devices described herein are not required to be etched, a broader selection of coatings is available, including coatings which would be difficult, or impossible, to etch. Segmented film deposition (“SFD”) can be used on polarizer structures such as those shown in U.S. Pat. Nos. 6,785,050; 6,208,463; 6,108,131; 6,710,921; 6,452,724; 6,122,103; and 6,243,199 which are herein incorporated by reference.

The segmented coating 71 can form segments or elongated beads aligned on top of the wires 75. Furthermore, the segments or beads can be wider than the wires 75. A maximum width w1 of the wires 75 can be less than a maximum width w2 of the coating 71 or beads thereof. The segments or beads can have a bulbous cross-sectional shape with a rounded top surface and that is narrower at a lower end with respect to a higher portion.

The segments or beads can have a symmetrical cross-sectional shape. The coating can extend down one side 72 to a distance d2 that is approximately the same as the coating distance d1 on an opposing side 73. For example, in one embodiment, an absolute value of a differential of these two distances, divided by a larger of the two distances D, can be less than 0.5, or

$$\frac{\vert {d}_{2} - {d}_{1} \vert}{D} < 0.5 .$$

In another embodiment, an absolute value of a differential of these two distances, divided by a larger of the two distances D, can be less than 0.2, or

$$\frac{\vert {d}_{2} - {d}_{1} \vert}{D} < 0.2 .$$

In another embodiment, an absolute value of a differential of these two distances, divided by a larger of the two distances D, can be less than 0.1, or

$$\frac{\vert {d}_{2} - {d}_{1} \vert}{D} < 0.1 .$$

Shown in FIG. 8 is a segmented film device 80 with a coating thickness T_{c} at the centerline C. In one embodiment, the coating thickness T_{c} at the centerline C is the largest coating thickness.

The coating 71 can be symmetrical across a width of the wires, such that a thickness on one side of the centerline C is approximately the same as a thickness on an opposite side, at an equivalent distance d from the centerline. This can be described mathematically as:

$$\frac{\vert {T}_{2} - {T}_{1} \vert}{T} < X .$$

T₁ and T₂ are coating thicknesses on either side of the centerline C at a distance d from the centerline C. Distance d is any distance along a surface of the coating 71 between the centerline C and a half-way point 83 between the centerline C and an edge 82 of the coating. T is a larger of the two thicknesses T₁ and T₂. In one embodiment, the value of X=0.5. In another embodiment, the value of X=0.2. In another embodiment, the value of X=0.1. In another embodiment, the value of X=0.05.

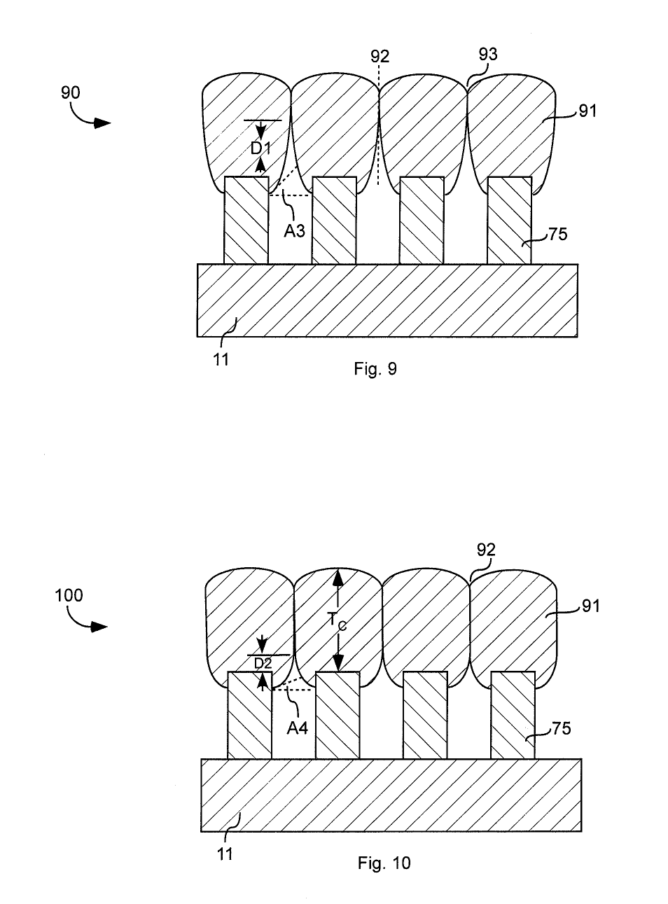

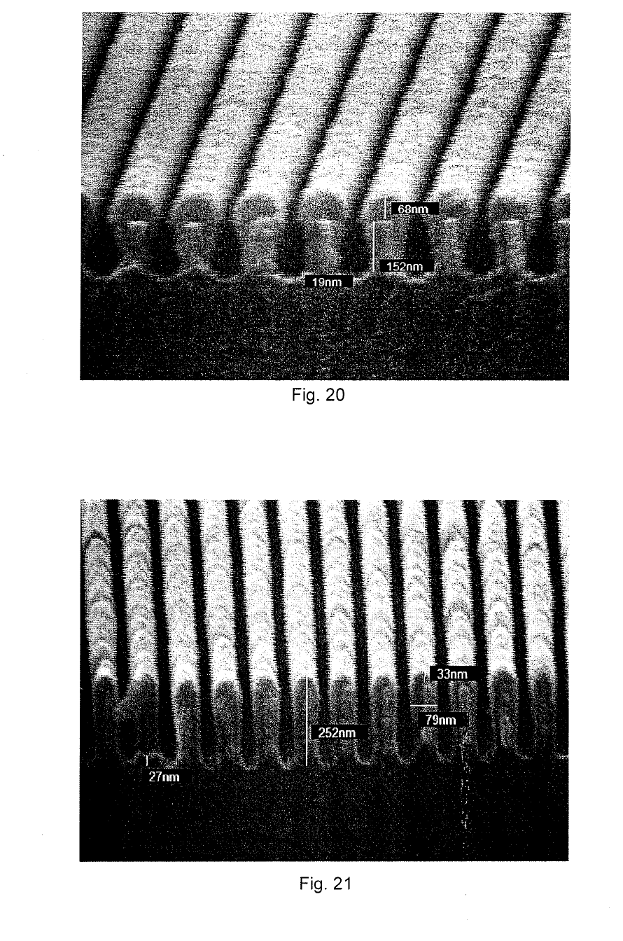

FIG. 9 shows a segmented film device 90 with coating 91 or beads on separate wires touching, indicated at 93, without attaching to one another to form a continuous layer. Although the coatings 91 or beads on top of different wires touch 93, a boundary or slip plane 92 exists between coatings of adjacent wires. This is distinct from the layer 61 shown in FIG. 6, in which there is no such separation in the coating for individual wires. Having a slip plane 92 between the coating or beads of different wires can result in increased device durability or flexibility as the coatings on separate wires can thus slide past each other as the device is flexed. Thus, the various embodiments of segmented film devices described herein can be made so that coatings 91 on adjacent wires 75 touch, without attaching to each other, as shown in FIGS. 9-10 and 18-19 or so that coatings 71 on adjacent wires 75 do not touch or contact each other, as shown in FIGS. 7-8, 11-17, and 20-21.

The process for applying the segmented coating 91 can be modified to alter the cross-sectional shape of the coating 91. For example, the cross-sectional shape of segmented film device 90 in FIG. 9 is different from the cross-sectional shape of segmented film device 100 in FIG. 10 by having a different depth D from the point where the coating 91 begins on the side of the wire to the point at which the segments on adjacent wires touch. Depth D1 in FIG. 9 is larger than depth D2 in FIG. 10. Also, angle A3 in FIG. 9 is larger than angle A4 in FIG. 10. The application process, such as sputtering, can be controlled to determine the coating 91 depth D at which the coating 91 touches. A smaller angle A4, and thus coating 91 touching at a lower depth D2, as in FIG. 10, may be advantageous if it is desired for the coating 91 on adjacent wires 75 to touch, but also have a smaller overall coating 91 thickness T_{c}. In other applications, it may be desirable to have a thicker coating 91, but only have a smaller point of contact, or smaller slip plane, to allow less friction at the slip plane, such as is shown in FIG. 9. A slower rate of coating 91 deposition results in the structure of FIG. 9, with a larger angle A3. A faster rate of coating 91 deposition results in the structure of FIG. 10, with a smaller angle A4.

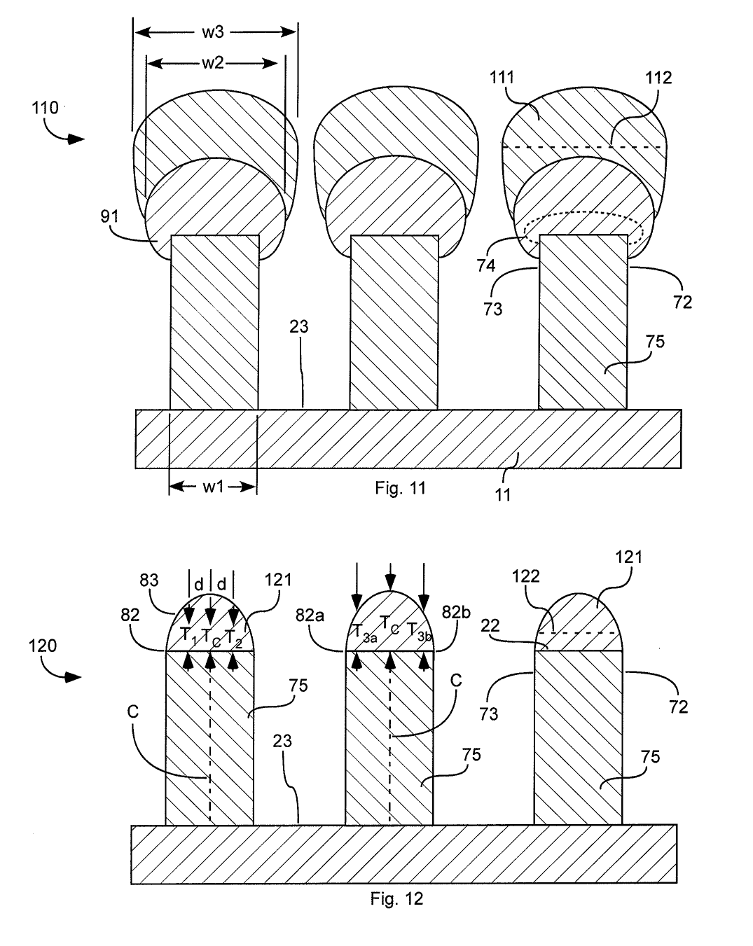

Shown in FIG. 11 is a segmented film device 110 with multiple coating layers, including a lower layer 91 and an upper layer 111. More layers may be used than the two layers shown. The maximum width w3 of the upper layer 111 can be wider than the maximum width w2 of a lower layer 91. Layers 91 and 111 can both be the same material or can be different materials. Layers 91 and 111 can each represent a single layer or can represent multiple layers such that there can be many more than two layers applied. Upper layer 111 can be continuous and homogeneous across a width 112 of the coating or upper layer. Lower layer 91 can be continuous and homogeneous from one side 72 of the wire to another side 73, as indicated by line 74.

Although not shown in FIG. 11, one of the segmented coating layers on one wire 75 can touch a segmented coating layer on an adjacent wire 75 without attaching to one another to form a continuous segmented coating layer, and defining a slip plane between the segmented coating layers on adjacent wires, similar to the segmented film devices 90 &100 shown in FIGS. 9-10.

Shown in FIG. 12 is a segmented film device 120 with coating 121 removed from wire 75 sidewalls 72 and 73. The coating 121 can be removed from wire 75 sidewalls 72 and 73 by an isotropic etch after deposition of the coating 121. The coating 121 can be continuous and homogeneous across a width 122 of the coating.

The coating 121 can be symmetrical across a width of the wires, such that a thickness on one side of the centerline C is approximately the same as a thickness on an opposite side, at an equivalent distance d from the centerline. This can be described mathematically as:

$$\frac{\vert {T}_{2} - {T}_{1} \vert}{T} < X .$$

T₁ and T₂ are coating thicknesses on either side of the centerline C at a distance d from the centerline C. Distance d is any distance along a surface of the coating 71 between the centerline C and a half-way point 83 between the centerline C and an edge 82 of the coating. T is a larger of the two thicknesses T₁ and T₂. In one embodiment, the value of X=0.5. In another embodiment, the value of X=0.2. In another embodiment, the value of X=0.1. In another embodiment, the value of X=0.05.

In one embodiment, the coating thickness T_{c} at the centerline C is the largest coating thickness. In another embodiment, thicknesses T_{3a-b}, at locations half-way between the centerline C of the coating and edges 82a-b of the coating, along a surface of the coating, are each less than 95% of the thickness of the coating at the centerline, or T₃<0.95*T_{c} (T₃ represents T₃ₐ or T_{3b}). In another embodiment, thickness T₃ is less than 75% of the thickness of the coating at the centerline T₃<0.75*T_{c}. In another embodiment, thickness T₃ is less than 50% of the thickness of the coating at the centerline, or T₃<0.5*T_{c}.

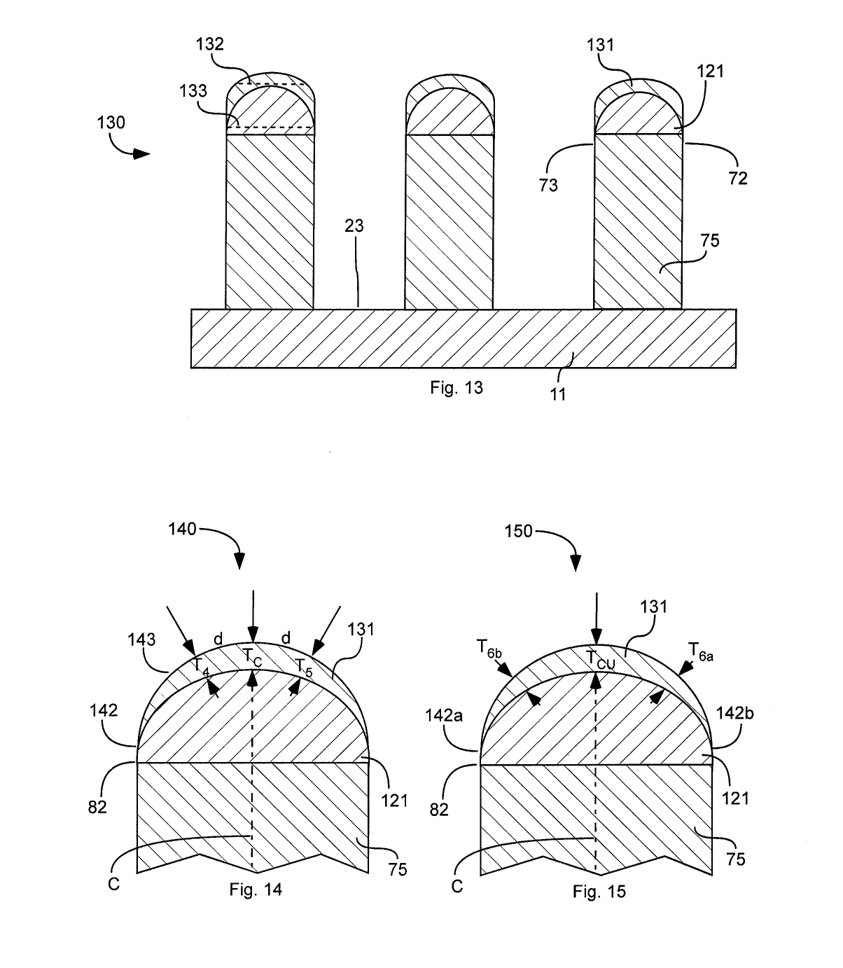

Shown in FIG. 13, segmented film device 130, like device 120 of FIG. 12, can have coating 121 removed from wire 75 sidewalls 72 and 73. Segmented film device 130 can also have multiple coating layers, including a lower layer 121 and an upper layer 131. More layers may be used than the two layers shown. Layers 121 and 131 can both be the same material or can be different materials. Each layer 121 and 131 can be continuous and homogeneous across a width 132 and 133 of the coating.

In addition to coating thickness relationships of coating 121 discussed above for segmented film device 120, the upper layer 131 of segmented film device 130 can also be symmetrical across a width of the wires, such that a thickness on one side of the centerline C is approximately the same as a thickness on an opposite side, at an equivalent distance d from the centerline. This symmetry is shown on expanded views of wires 75 in FIGS. 14 and 15. This symmetry can be described mathematically as follows. In one embodiment, an absolute value difference of thicknesses T₅ and T₄ divided by a larger of the two thicknesses T is less than 0.5,

$$\frac{\vert {T}_{5} - {T}_{4} \vert}{T} < 0.5 .$$

In another embodiment, an absolute value difference of thicknesses T₅ and T₄ divided by a larger of the two thicknesses T is less than 0.2, or

$$\frac{\vert {T}_{5} - {T}_{4} \vert}{T} < 0.2 .$$

In another embodiment, an absolute value difference of thicknesses T₅ and T₄divided by a larger of the two thicknesses T is less than 0.1, or

$$\frac{\vert {T}_{5} - {T}_{4} \vert}{T} < 0.1 .$$

In another embodiment, an absolute value difference of thicknesses T₅ and T₄ divided by a larger of the two thicknesses T is less than 0.05, or

$$\frac{\vert {T}_{5} - {T}_{4} \vert}{T} < 0.05 .$$

Distance d is a distance along a surface of the coating 131 between the centerline C and a half-way point 143 between the centerline C and an edge 142 of the coating. Thicknesses T₄ and T₅ are thicknesses of the upper layer 131 at distance d on either side of the centerline.

In one embodiment, coating thickness T_{cu}, of upper layer 131, at the centerline C, is the largest coating thickness. In another embodiment, thicknesses T_{6a-b}, at locations half way between the centerline C of the coating and edges 142a-b of the coating, along a surface of the coating, are less than 95% of the thickness of the coating at the centerline, or T₆<0.95*T_{c} (meaning both T₆ₐ and T_{6b} are less than 0.95). In another embodiment, thicknesses T_{6a-b} are less than 75% of the thickness of the coating at the centerline, or T₆<0.75*T_{c}. In another embodiment, thicknesses T_{6a-b} are less than 50% of the thickness of the coating at the centerline, or T₆<0.5*T_{c}

Note that thicknesses T₄, T₅, and T₆ are measured at an angle that is perpendicular to the lower layer or wire. All coating measurements described herein are to be defined as the distance of the coating in a perpendicular direction from the underlying coating or wire.

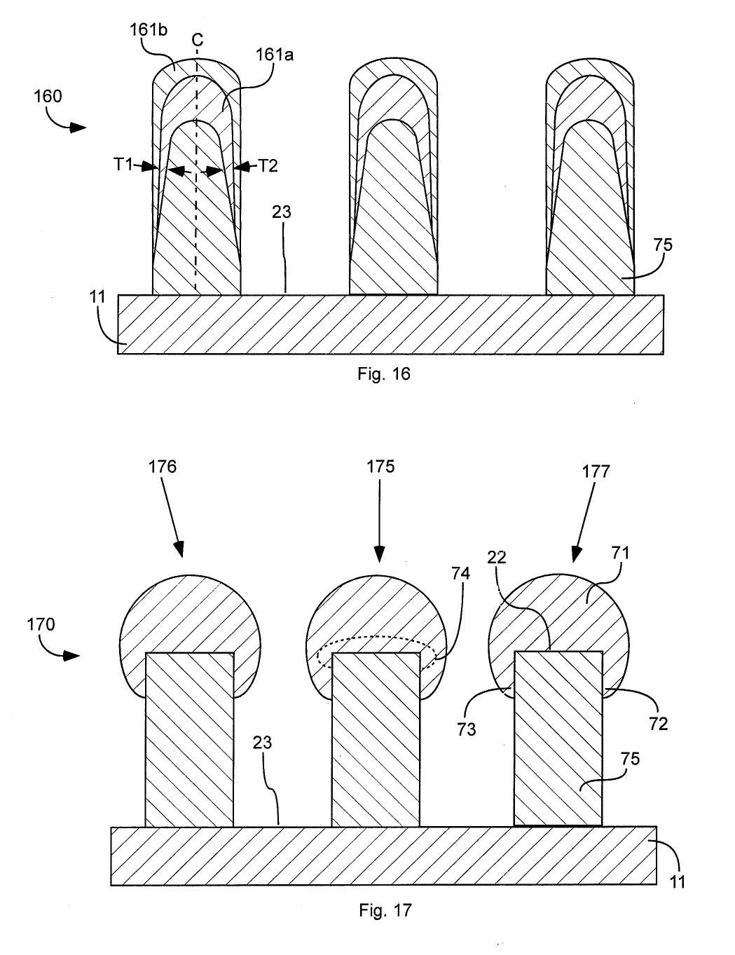

Although the wires 75 in previously described figures are shown as rectangular in shape, segmented film devices can be made on wires of other shapes. For example, shown in FIG. 16 is a segmented film device 160 with wires 75 that have a rounded top. Coatings 161a-b can conform to this rounded top shape. The various segmented film device embodiments described herein are applicable to rectangular shaped wires and to other shaped wires, such as the wires in FIG. 16 that have a rounded top shape.

Shown in FIG. 17, segmented film device 170 can be made by forming an array of parallel spaced-apart wires 75 on a substrate 11 and depositing a segmented film 71 on the wires comprising individual segments on individual wires.

The deposition can be performed such that (1) there is no substantial coating 71 of the substrate 11 between the wires 23; (2) the segments are aligned with the wires 75; (3) the segments are continuous and homogeneous 74 across a width of the coating and from one side of the wires to the other side; (4) the segments continue partially down both sides of the wires without coating the substrate 11 exposed between 23 the wires 11; and (5) segments on wires are separate and distinct from each other.

Deposition in the above method is normally performed at normal incidence, as shown by line 175. Deposition can be performed slightly off of normal incidence, such as up to about fifteen degrees from normal incidence, as shown by either line 176 or line 177.

Deposition can further include depositing the segmented film until the segments touch one another without attaching to one another to form a continuous layer, and defining a slip plane therebetween, as shown in FIGS. 9-10 and 18-19.

Deposition can further include depositing at least one additional segmented film layer on the wires, each segmented film is continuous and homogeneous across a width of the coating, and each segmented film layer is deposited in a single deposition step. Multilayer segmented film deposition devices are shown in FIGS. 11 and 13-16.

The above method can further include removing coating on sides of the wires 75 with an isotropic etch, thus producing a segmented film device as shown in FIGS. 12-15.

The above method can be used to produce a wire grid polarizer with electrically conductive wires 75 and a pitch of the wires or wires 75 can be less than 150 nanometers, less than 130 nanometers, less than 110 nanometers, or less than 90 nanometers.

### How to Make:

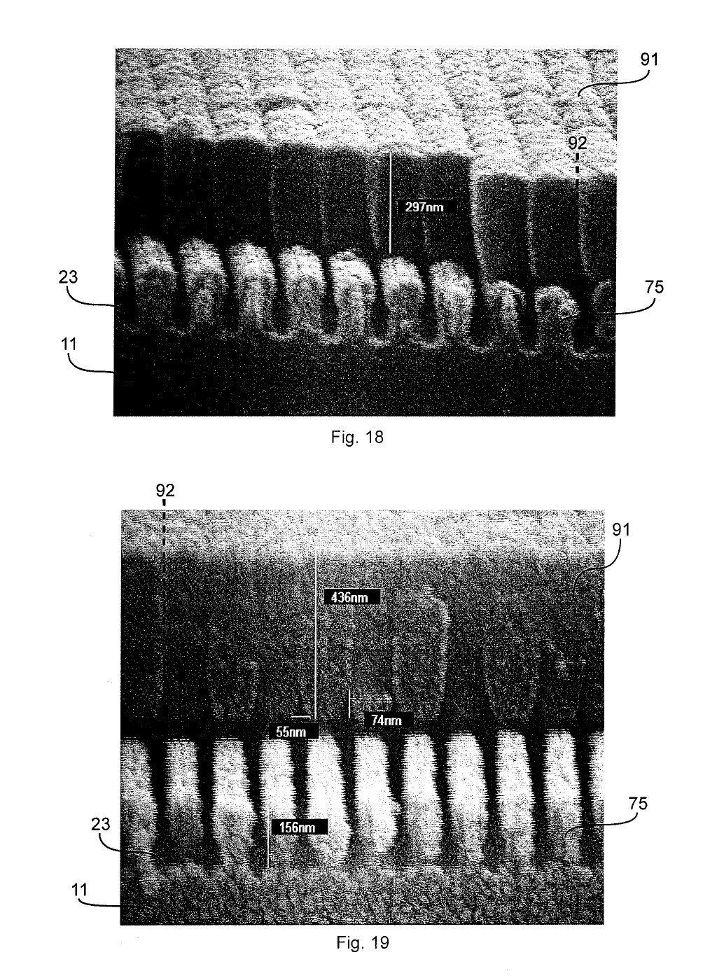

Successful SFD has been performed on a NEXX Nimbus 5000 sputter coater to apply a coating of silicon dioxide and silicon nitride, with power of 5000 watts, chamber pressure of 4 mtorr, argon flow of 28 sccm, oxygen flow of 43 sccm, scan length of 325 mm, scan speed of 42.2 mm/sec. SFD was applied on wire grid polarizers on 200 mm wafers with wire grid pitch of about 120 nm, wire height of 20-220 nm, and wire width of 40-60 nm. SEM photographs of SFD coatings are shown in FIGS. 18-21.

SFD may be optimized by adjusting the process parameters of chamber pressure, power settings, sputter gas flow rate, dilution gas flow rate, type of reactive gas used, bottom chuck bias, chuck temperature, alignment of target to wafer, wafer size, wire aspect ratio, and wire pitch.

Process parameters that result in a slower rate of growth of the coated material, such as a lower chamber pressure or lower power, result in a more vertical profile of the coated material 91, or larger angle A3, as shown in FIG. 9. Process parameters that result in a faster rate of growth of the coated material, such as a higher chamber pressure or higher power, result in a less vertical profile of the coated material 91, or smaller angle A4, as shown in FIG. 10.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully descwireed above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A segmented film device, comprising:
a) a substrate;
b) a generally parallel arrangement of thin, elongated wires disposed over the substrate, the wires having a surface opposite the substrate and sides extending down to the substrate;
c) a segmented coating on the surface of the wires and continuing partially down both sides of the wires into channels between the wires without coating the substrate exposed between the wires; and
d) the coating is continuous and homogeneous from one side of the wire to another side.

2. The device of claim 1, wherein the segmented coating is wider than the wires.

3. The device of claim 1, wherein:
a) the coating forms an array of elongated beads aligned on top of the wires; and
b) adjacent beads touch one another without attaching to one another to form a continuous layer, and defining a slip plane therebetween.

4. The device of claim 1, wherein an absolute value of a thickness of the coating layers at distance on one side of a centerline of the wires minus a thickness of the coating at the same distance d on an opposite side of the centerline divided by a larger of the two thicknesses is less than 0.5, wherein distance is a distance along a surface of the coating between the centerline and a half-way point between the centerline and an edge of the coating.

5. The device of claim 1, wherein an absolute value of a thickness of the coating layers at distance on one side of a centerline of the wires minus a thickness of the coating at the same distance d on an opposite side of the centerline divided by a larger of the two thicknesses is less than 0.5, wherein distance is a distance along a surface of the coating between the centerline and a half-way point between the centerline and an edge of the coating.

6. The device of claim 1, wherein the coating extends in a continuous and homogeneous layer from one side of the wires to an opposite side with no boundary conditions therebetween.

7. The device of claim 1, wherein the coating defines a lower layer and includes at least one additional layer, defining an upper layer, disposed farther from the substrate than the lower layer, and each layer is continuous and homogeneous across a width of the layer.

8. The device of claim 7, wherein a maximum width of the upper layer is wider than a maximum width of the lower layer.

9. The device of claim 1, wherein the generally parallel arrangement of thin, elongated wires includes a conductive material forming wires spaced apart with a pitch less than a wavelength of incident light defining a wire-grid polarizer.

10. The device of claim 1, wherein the coating is dielectric.

11. A wire grid polarizer device, comprising:
a) a substrate;
b) a generally parallel arrangement of thin, elongated electrically conductive wires disposed over the substrate, the wires having a surface opposite of the substrate and sides extending down to the substrate;
c) a symmetrical, segmented coating disposed on the surface of the wires without coating the substrate exposed between the wires;
d) the coating is continuous and homogeneous across a width of the coating;
e) the coating is thickest at a centerline of the wires;
f) thicknesses of the coating at locations half-way between the centerline and edges of the coating are less than 75% of a thickness of the coating at the centerline.

12. The device of claim 11, wherein an absolute value of a thickness of the coating layers at distance on one side of a centerline of the wires minus a thickness of the coating at the same distance on an opposite side of the centerline divided by a larger of the two thicknesses is less than 0.5, wherein distance is a distance along a surface of the coating between the centerline and a half-way point between the centerline and an edge of the coating.

13. The device of claim 11, wherein an absolute value of a thickness of the coating layers at distance d on one side of a centerline of the wires minus a thickness of the coating at the same distance on an opposite side of the centerline divided by a larger of the two thicknesses is less than 0.5, wherein distance is a distance along a surface of the coating between the centerline and a half-way point between the centerline and an edge of the coating.

14. The device of claim 11, wherein thicknesses of the coating at locations half-way between the centerline and edges of the coating are less than 50% of a thickness of the coating at the centerline.

15. The device of claim 11, wherein:
a) the coating includes at least two layers;
b) each layer is continuous and homogeneous across a width of the layer;
c) each layer is thickest at a centerline of the wires;
d) thicknesses of each layer at locations half-way between the centerline and edges of the layer are less than 75% of a thickness of the layer at the centerline for that layer.

16. The device of claim 11, wherein the wires have a pitch of less than 150 nanometers.

17. A wire grid polarizer device, comprising:
a) a substrate;
b) a generally parallel arrangement of thin, elongated electrically conductive wires disposed over the substrate, the wires having a surface opposite of the substrate and sides extending down to the substrate;
c) at least two segmented coating layers on the surface of the wires without the at least two segmented coating layers coating the substrate between the wires;
d) the at least two segmented coating layers on a wire do not attach to segmented coating layers on adjacent wires;
d) the at least two segmented coating layers are continuous and homogeneous across a width of the at least two segmented coating layers;
e) at least two of the at least two segmented coating layers each have thicknesses at locations half-way between the centerline and edges of the at least two segmented coating layers that are less than 95% of a thickness at the centerline; and
g) at least two of the at least two segmented coating layers each have an absolute value of a thickness at distance on one side of a centerline of the wires minus a thickness of the coating at the same distance on an opposite side of the centerline divided by a larger of the two thicknesses is less than 0.5, wherein distance is a distance along a surface of the coating between the centerline and a half-way point between the centerline and an edge of the coating.

18. The device of claim 17, wherein at least one of the at least two segmented coating layers on one wire touches a segmented coating layer on an adjacent wire without attaching to one another to form a continuous segmented coating layer, and defining a slip plane between the segmented coating layers on adjacent wires.

19. The device of claim 17, wherein at least two of the at least two segmented coating layers each have thicknesses at locations half-way between the centerline and edges of the at least two segmented coating layers that are less than 75% of a thickness at the centerline.

20. The device of claim 17, wherein at least two of the at least two segmented coating layers each have an absolute value of a thickness at distance on one side of a centerline of the wires minus a thickness of the coating at the same distance on an opposite side of the centerline divided by a larger of the two thicknesses is less than 0.2, wherein distance is a distance along a surface of the coating between the centerline and a half-way point between the centerline and an edge of the coating.

21. The device of claim 17, wherein the wires have a pitch of less than 150 nanometers.

22. A wire grid polarizer, comprising:
a) a substrate;
b) a generally parallel arrangement of thin, elongated electrically conductive wires disposed over the substrate, the wires having a surface opposite of the substrate and sides extending down to the substrate;
c) a symmetrical coating on the surface of the wires without coating the substrate exposed between the wires;
d) the coating is continuous and homogeneous across a width of the coating; and
e) thicknesses of the coating at locations half-way between the centerline and edges of the coating are less than 75% of a thickness of the coating at the centerline.

23. A method of performing segmented film deposition, comprising;
a) forming an array of parallel spaced-apart wires on a substrate; and
b) depositing a segmented film on the wires comprising individual segments on individual wires wherein:
i) the deposition is performed with no substantial coating of the substrate between the wires;
ii) the segments are aligned with the wires;
iii) the segments are continuous and homogeneous across a width of the coating and from one side of the wires to the other side;
iv) the segments continue partially down both sides of the wires without coating the substrate exposed between the wires; and
v) segments on wires are separate and distinct from each other.

24. The method of claim 23, wherein depositing further includes depositing the segmented film until the segments touch one another without attaching to one another to form a continuous layer, and defining a slip plane therebetween.

25. The method of claim 23, wherein depositing further includes depositing at least one additional segmented film layer on the wires, each segmented film is continuous and homogeneous across a width of the coating, and each segmented film layer is deposited in a single deposition step.

26. The method of claim 23, wherein the deposition is performed from normal incidence.

27. The method of claim 23, wherein the deposition is performed within fifteen degrees from normal incidence.

28. The method of claim 23, further comprising removing coating on sides of the wires with an isotropic etch.

29. The method of claim 23, wherein the wires are conductive wires with a pitch of less than 150 nanometers.
